(19) United States
(12) Patent Application Publication
(10) Pub. No.: US 2011/0028625 A1
(43) Pub. Date: Feb. 3, 2011

(54) LOW VOC AND FOG, LOW TEMPERATURE PVC FOR SEAMLESS AIR BAG DOORS

(75) Inventor: William J. Tansey, Lee, NH (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: International Automotive Components Group North America, Inc., Dearborn, MI (US)

(21) Appl. No.: 12/534,396

(22) Filed: Aug. 3, 2009

(51) Int. Cl. C08L 27/06

(52) U.S. Cl. 524/297

(57) ABSTRACT

The present invention relates to a slush moldable polymeric composition that is usable in a seamless air bag door skin and methods of making the same. In at least one embodiment, the composition comprises from 35 to 60 wt. percent of a first PVC resin, from 30 to 50 wt. percent of a linear trimellitate plasticizer, and from 1 to 20 wt. percent of an adipate ester plasticizer. The composition is melt processible and is useable to make seamless air bag doors that work successfully in low and high temperatures and have low emissions of VOCs and a low odor grade.

### BACKGROUND OF THE INVENTION

1. Field of the Invention

The present invention relates to moldable polymeric compositions that are useful for making instrument panel skins and other trim panel components used in automobile interiors.

2. Background Art

Current air bag doors are often integrated into the instrument panels of the vehicle to give a more seamless and “invisible” appearance. The instrument panel skins must therefore meet certain test criteria and have certain performance characteristics so they perform adequately in a range of conditions, such as high and low temperatures. Low temperatures, for example −35° C., can cause problems such as brittleness in the skin, which leads to fragmentation during deployment that can cause injury to the passengers. At high temperatures, for example 85° C., the physical properties of the skin can begin to change and affect the performance of the air bag.

It is desirable to limit the amount of volatile organic compounds (VOCs) and odor of the instrument panel skins. Lowering the amount of VOCs mitigates the amount of windshield “fog” that can sometimes form as a result of vapors escaping from the instrument panel skins. It is desirable to limit the amount of total carbon emissions to less than or equal to 50 micrograms of carbon per gram of material.

Instrument panel skins are often made using slush molding due to the desirable feel it produces and the high level of detail that it allows. Accordingly, a slush moldable polymeric composition for instrument panel skins that performs well at high and low temperatures, has low amounts of VOCs, and has low odor would be beneficial.

### SUMMARY OF THE INVENTION

In one aspect of the invention, a polymeric composition is provided. In at least one embodiment, the polymeric composition comprises:

a) from 35 to 60 wt. percent of a first poly vinyl chloride resin;

b) from 30 to 50 wt. percent linear trimellitate plasticizer; and

c) from 1 to 20 wt. percent adipate ester plasticizer;

wherein the polymeric composition is melt processible to form a skin having volatile organic compound emissions of at most 50 μg C/g.

In another aspect of the invention, a vehicle skin is provided. In at least one embodiment, the skin comprises the dried product of a composition comprising:

a) from 35 to 60 wt. percent of a first poly vinyl chloride resin;

b) from 30 to 50 wt. percent linear trimellitate plasticizer; and

c) from 1 to 20 wt. percent adipate ester plasticizer;

wherein the polymeric composition is melt processible to form a skin having volatile organic compound emissions of at most 50 μg C/g.

In yet another aspect of the invention, a method for processing a polymeric composition is provided. In at least one embodiment, the method comprises:

a) providing components of the polymer composition, including at least a first poly vinyl chloride resin, a linear trimellitate plasticizer, and an adipate ester plasticizer;

b) inserting at least the PVC resin and a first portion of a blend of the trimellitate and the adipate ester plasticizers into a high intensity mixer;

c) heating the contents of the mixer to a temperature of 170° F. to 220° F. while the mixer is in a first high shear mode;

d) switching the mixer to a first low shear mode and inserting a remaining portion of the trimellitate and adipate ester plasticizers;

e) returning the mixer to a second high shear mode and heating the contents of the mixer to a temperature of 245° F. to 255° F.; and

f) switching the mixture to a second low shear mode and heating the contents of the mixer to a temperature of 255° F. to 265° F.;

wherein the polymeric composition comprises from 35 to 60 wt. percent of a first poly vinyl chloride resin; from 30 to 50 wt. percent linear trimellitate plasticizer; and from 1 to 20 wt. percent adipate ester plasticizer, and wherein the first portion of the blend of the plasticizers comprises 50% to 70% of the total plasticizer weight.

### BRIEF DESCRIPTION OF THE DRAWINGS

FIGS. 1A and 1B together illustrate pictorial flowchart depicting an embodiment for forming an instrument panel skin; and

FIG. 2 is a pictorial flowchart depicting the application of a support structure to an instrument panel skin.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for the claims and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; and the first definition of an acronym or other abbreviation applies to all subsequent uses herein of the same abbreviation and applies mutatis mutandis to normal grammatical variations of the initially defined abbreviation.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

A slush moldable polymeric composition suitable for automotive interior panels is hereby provided. The composition generally comprises at least one PVC resin and at least one plasticizer, as well as other components conventionally present in PVC instrument panel compositions.

An automotive interior panel including a skin made of the slush moldable polymeric composition is also provided. The panel may be made by slush molding and may be incorporated into a seamless air bag door having a service temperature range of at least −35° C. to 85° C. The panel may also have a low amount of VOCs, making it resistant to windshield fogging, and have low odor.

In at least one embodiment, the polymeric composition comprises a PVC suspension resin in an amount from 35% to 60%, in another embodiment from 37.5% to 55%, and in yet another embodiment 40% to 50%, and in still yet another embodiment about 45%. The PVC suspension resin preferably has a high porosity so that it can accommodate a large amount of plasticizer. In at least one embodiment, the porosity may be from 0.40 to 0.70 cm³/g, in another embodiment from 0.42 to 0.65 cm³/g, in yet another embodiment from 0.50 to 0.60 cm³/g, and in yet another embodiment about 0.54 cm³/g. Porosity can be measured using a Brabenoer Torque Rheometer (or plasticorder). An example of an acceptable PVC resin is Geon™ 471 PVC Homopolymer, available from the PolyOne Corporation.

In at least one embodiment, the polymeric composition includes a trimellitate plasticizer, which is preferably linear. The trimellitate plasticizer may be present in an amount from 30% to 50% of the polymeric composition, in another embodiment from 35% to 45%, and in yet another embodiment from 37% to 41%. The trimellitate plasticizer helps give automotive interior panels made from the composition a wider service temperature range by increasing low temperature flexibility and reducing degradation at high temperatures. Trimellitates also have lower amounts of VOCs when compared to other plasticizers, such as phthalates. In at least one embodiment, the trimellitate has a molecular weight of 500 to 650, in another embodiment from 550 to 600, and in yet another embodiment from 575 to 595. An example of an acceptable trimellitate plasticizer is Palatinol® 610™, available from BASF, or n-actyl, n-decyl, trimellitate (NONO™), available from Reicholo Chemicals.

In general, to achieve acceptable low and high temperature performance a high weight percent of plasticizers should be used, preferably at least 100 parts plasticizer per 100 parts PVC suspension resin. The predominant plasticizer may be a linear trimellitate. Previous PVC compositions have often had under 30% trimellitate because the PVC cannot hold more than that using conventional resins and conventional processing. In at least one embodiment of the polymeric composition, a highly porous PVC resin, such as Geon™ 471, is used with at least 30% linear trimellitate plasticizer, such as Palatinol® 610™. Linear trimellitates are preferred because they are more readily incorporated into the PVC resin, compared to branched trimellitates. Moreover, linear trimellitates have better low temperature performance than branched trimellitates.

Additional components in the polymeric composition may include, among other things, additional plasticizers, a PVC dispersion resin, pigments, heat and light stabilizers, mold release agents, and stearic acid. The other plasticizers may comprise a monomeric adipate ester plasticizer such as Plasthall® CF from HallStar or other adipate ester plasticizers, including modified adipate ester plasticizers. The adipate ester plasticizer typically has a slightly higher VOC content than the trimellitate, but gives better low temperature properties (e.g. less fragmentation) to skins made with the polymeric composition. In at least one embodiment of the polymeric composition, the adipate ester may be present in an amount from 1% to 20%, in another embodiment 5% to 15%, and in yet another embodiment about 10%.

The PVC dispersion resin may be a low molecular weight PVC homopolymer such as Formolon®-24A, available from Formosa Plastics. In at least one embodiment of the polymeric composition, the dispersion resin is present in an amount from 1% to 10%, in another embodiment from 2% to 5%, and in yet another embodiment about 3%.

Heat stabilizers, such as Therm-Chek® 1187 from the Ferro Corporation, may be present in the polymeric composition in an amount from 0.5% to 5%, in another embodiment from 1% to 3%, and in yet another embodiment 1.5% to 2.5%. Light stabilizers, such as TINUVIN® XT 833 from Ciba, may also be included. In at least one embodiment of the polymeric composition, the light stabilizer is present in an mount from 0.1% to 2.0%, in another embodiment from 0.15% to 1.0%, and in yet another embodiment 0.2% to 0.5%.

Mold release agents, such as high molecular weight fatty acid esters may be incorporated. An example of an acceptable release agent is LOXIOL® G71S, and it may be present in an amount from 0.1% to 2.0% in the polymeric composition. In another embodiment the release agent may be present in an amount from 0. 15% to 1.0%, and in yet another embodiment it may be present in an amount from 0.2% to 0.5%.

Stearic acid may be included in the composition as well. In at least one embodiment of the polymeric composition, stearic acid is present in an amount from 0.01% to 1.0%, in another embodiment from 0.02% to 0.1%, and in yet another embodiment from 0.03% to 0.07%. If coloration is desired, up to about 5% pigment may be added to the composition, such as 5B8A charcoal black masterbatch by Microcolor Dispersions.

In addition to using the highly porous PVC resin and linear trimellitate, the processing method also helps to increase the incorporated plasticizer content of the polymeric composition. The composition can be made by dry blending of the components in a high intensity mixer, such as a Henschel mixer. The PVC suspension resin and any other dry components are added to the mixer, and may be optionally heated to 50° F. to 190° F. before the plasticizer(s) are added. A first portion of a blend of the trimellitate and adipate ester plasticizers may then be added to the mixer. In at least one embodiment of the method, 40% to 80% of the total plasticizer weight is added as the first portion, in another embodiment 50% to 70%, and in yet another embodiment about 60%. If about 60% of the total plasticizer is added in the first portion, in at least one embodiment the 60% may comprise about 75% of the total linear trimellitate plasticizer to be added. The plasticizer blend may optionally be pre-heated to 150° F. to 200° F. before being added to the mix, preferably about 190° F.

The mix is then heated under high shear to 180° F. to 220° F., preferably about 200° F. Once the mix has reached the desired temperature, the shear is reduced to low and the remaining plasticizer and any other liquid components of the composition, if present, are added to the mix. “High shear” may be from 600 to 900 RPM's in at least one embodiment, 700 to 800 RPM's in another embodiment, and about 750 RPM's in yet another embodiment. “Low shear” may be from 300 to 500 RPM's in at least one embodiment, from 350 to 450 RPM's in another embodiment, and about 400 RPM's in yet another embodiment.

In at least one embodiment, the remaining plasticizer comprises about 40% of the total plasticizer to be added. In at least one embodiment, the 40% remaining plasticizer may comprise 25% of the total linear trimellitate and substantially all of the adipate ester plasticizer to be added. The plasticizer and liquid components may also have optionally been pre-heated to 180° F. to 200° F., preferably about 190° F., before adding to the mixer. The mixer is then returned to high shear and the temperature is increased to 245° F. to 255° F., preferably about 250° F. Once this temperature is reached the shear is returned to low and the temperature is increased to 255° F. to 265° F., preferably about 262° F. The mix is then cooled, and a PVC dispersion resin may be added to “scavenge” the un-reacted plasticizer by absorbing any residual plasticizer remaining on the surface of the PVC resin. In at least one embodiment, to increase the bulk density of the of the dry blend, it is possible to add up to 15% calcium carbonate filler to the mix as soon as the mix is discharged into a cooler, when the temperature is from 255 to 265° F., preferably about 262° F.

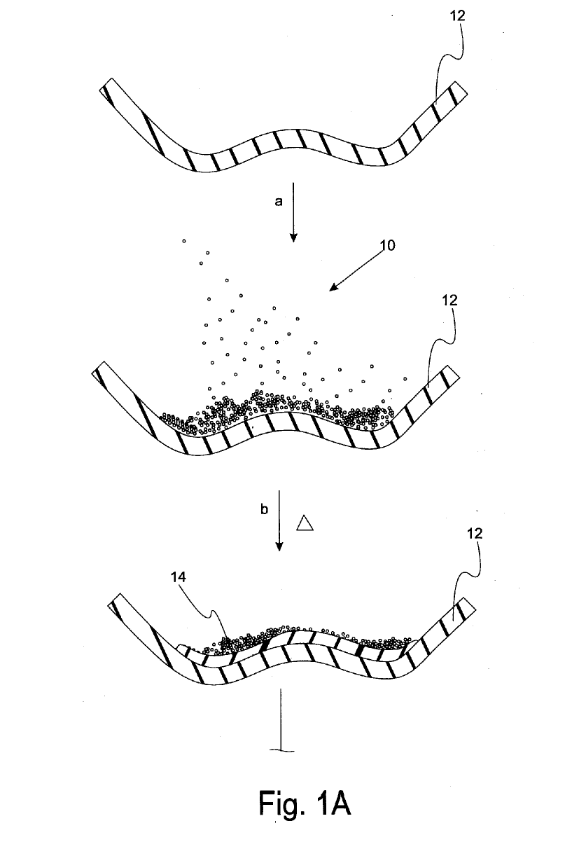

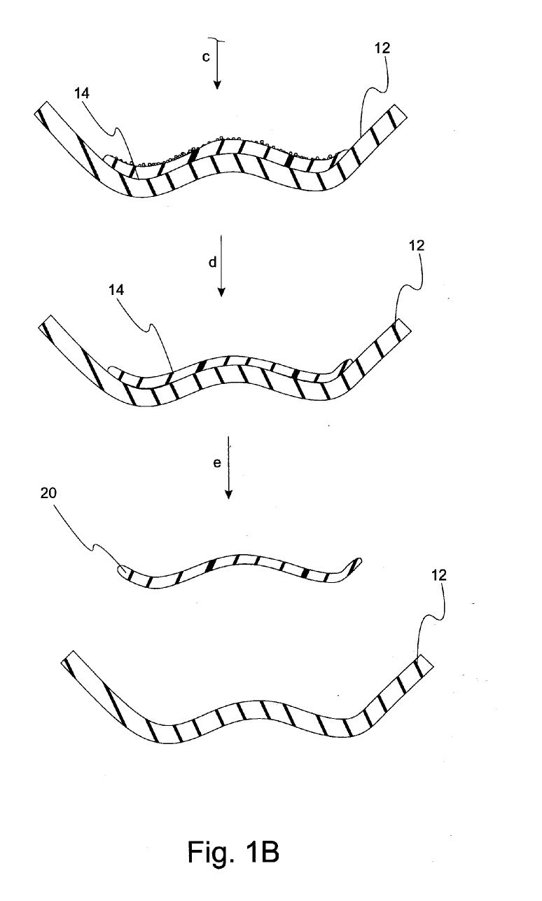

In at least one embodiment, the polymeric composition may be used in the formation of an instrument panel skin for a vehicle. With reference to FIGS. 1A and 1B, a pictorial flowchart depicting a slush molding method for forming an instrument panel skin is provided. The method of this embodiment comprises a first step a) of introducing a polymeric composition 10 into mold tool 12. The composition 10 may be made into small particles suitable for slush molding by any of the methods well known in the art, such as cryogenic grinding, if not already in a suitable form. At least a portion of mold tool 12 is made from a metal such as stainless steel or nickel.

In a subsequent step b), composition 10 is heated to a sufficient temperature to form layer 14 over at least a portion of mold tool 12. In step c), excess powder is poured out from mold tool 12. The mold tool 12 is further heated, if necessary, in step d) so that the remaining powder melts. Finally, instrument panel skin 20 is removed from mold tool 12 in step e).

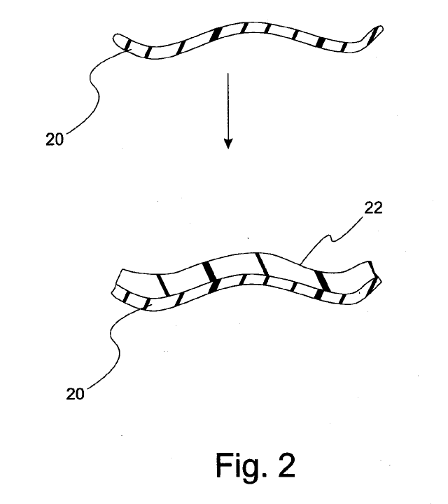

With reference to FIG. 2, a flowchart showing the application of a backing to instrument panel skin 20 is provided. In step f), structural component 22 is applied to instrument panel skin 20. Such structural components are applied by any number of methods known to those skilled in the art. In one refinement, structural component 22 has a thickness from about 2 mm to about 20 mm. In some variations, foam resins such as Dow Specflex NM815 are utilized. In one variation, skin 20 may be placed in a mold that provides a predetermined shape and a urethane backing is sprayed over the back of instrument panel skin 20. In another variation, structural component 22 can be molded onto instrument panel skin 20. In such circumstances thermoplastic resins may be used.

The skin 20 may be used in a seamless, “invisible” air bag door in a vehicle instrument panel. In at least one embodiment, the skin may be used in a seamless air bag door for a side air bag. In this embodiment the skin is capable of service temperatures ranging from at least -35° C. to 85° C. At -35° C. the skin functions without becoming overly brittle and does not have fragmentation during air bag deployment. During thermal aging for 500 hours at 120° C., the skin has a change in tensile strength in at least one embodiment of at most about 10%, either higher or lower, in another embodiment of at most about 5%, and in yet another embodiment of at most about 2.5%. During the same thermal aging, the skin has a change in tear strength in at least one embodiment of at most about 25%, either higher or lower, in another embodiment of at most about 20%, and in yet another embodiment of at most about 15%. During the same thermal aging, the skin has a change in elongation at break in at least one embodiment of at most about 5%, either higher or lower, in another embodiment of at most about 2.5%, and in yet another embodiment of at most about 1%.

The physical properties of the skin can affect the low and high temperature success of the air bag deployment. In at least one embodiment, the skin 20 may have a glass transition temperature, T_{g}, of less than −25° C., in another embodiment less than −50° C., and in yet another embodiment less than −60° C. The tear strength of the skin helps determine the ability of the skin to perform without fragmenting at low temperatures. In at least one embodiment, the tear strength of the skin is from 20 to 50 kN/m when measured using ASTM D1004, in another embodiment from 25 to 40 kN/m, and in yet another embodiment from 30 to 35 kN/m. The tensile strength at yield of the skin can also influence whether or not fragmentation occurs during air bag deployment. In at least one embodiment, the tensile strength at yield is from 7 to 12 MPa when measured using ASTM D412, in another embodiment from 8 to 11 MPa, and in yet another embodiment from about 9 to 10 MPa. The elongation at break of the skin, when measured using ASTM D412 may be at least 250% in at least one embodiment, at least 300% in another embodiment, and at least 325% in yet another embodiment. Lower tear and tensile strengths typically decrease the likelihood of fragmentation when the skin is used as an air bag door.

The skin 20 may also have very low amounts of volatile organic compounds (VOCs) in order to reduce or eliminate the “fogging” on vehicle windows and windshields that occurs when such compounds are released from the skin over time. In at least one embodiment, using the Volkswagen PV3341 test method, the amount of total carbon emission from the skin is less than 50 μg C/g, in another embodiment less than 25 μg C/g, in yet another embodiment less than 10 μg C/g, and in still yet another embodiment less than 5 μg C/g. Briefly, the PV 3341 test method involves heating a vial containing the sample for 5 hours at 120° C. and analyzing the vial contents with a gas chromatograph.

For some vehicles it may also be desirable for the skin to have very little odor, which may also be accomplished using the trimellitate and adipate ester plasticizers. Odor may be measured using a standardized protocol, such as Volkswagen PV3900. Briefly, in this test a sample of the material to be tested is subjected to three different heat and time conditions and then is evaluated on a scale with grades 1-6, with 1 being “not perceptible” and 6 being “unbearable.” The first test condition is at 23° C. for 24 hours, the second condition is at 40° C. for 24 hours, and the third condition is at 80° C, for 2 hours. In at least one embodiment, the skin 20 may have an odor grade of at most 3.0 on the odor scale for all three conditions, in another embodiment the skin may have an odor grade of at most 2.0 for all three conditions, and in yet another embodiment the skin may have an odor grade of about 1.5 for all three conditions.

The above properties make the skins made from the various embodiments of the present invention highly suitable for invisible air bag doors. Compared to other skins using different plasticizers, such as phthalates, skins made from the polymeric compositions described above have lower tear strengths, lower T_{g}'s, lower VOC emissions, and lower odor, all of which typically are beneficial to air bag door skins. For example, a PVC alloy using phthalate plasticizer is described in US2006/0252885. The composition and properties of the alloy are listed in Tables 3 and4.

The following examples illustrate the various embodiments of the present invention. Those skilled in the art will recognize many variations that are within the spirit of the present invention and scope of the claims.

Table 1 provides suitable ranges of some of the components in the composition.

Table 2 provides the composition of a test sample that was used to form skin layers via a slush molding process.

Table 3 provides test data on some physical properties of a skin prepared with the composition of table 2.

TABLE 1
Component ranges

| | First | Second | Third |
|---|---|---|---|
| Component | Embodiment | Embodiment | Embodiment |
| PVC suspension | 35% to 60% | 37.5% to 55% | 40% to 50% |
| resin | | | |
| trimellitate | 30% to 50% | 35% to 45% | 37% to 41% |
| plasticizer | | | |
| adipate ester | 1.0% to 20% | 5.0% to 15% | ~10% |
| plasticizer | | | |
| PVC dispersion | 0% to 10% | 2.0% to 5.0% | ~3.0% |
| resin | | | |
| heat stabilizers | 0% to 5.0% | 1.0% to 3.0% | 1.5% to 2.5% |
| light stabilizers | 0% to 2.0% | 0.15% to 1.0% | 0.2% to 0.5% |
| mold release | 0% to 2.0% | 0.15% to 1.0% | 0.2% to 0.5% |
| agents | | | |
| stearic acid | 0% to 1.0% | 0.02% to 0.1% | 0.03% to 0.07% |
| pigment/coloring | 0% to 5% | ≦5% | ≦5% |
| agent | | | |
| calcium carbonate | 0% to 15% | ≦15% | ≦15% |

TABLE 2
Sample composition

| Component | Wt. % |
|---|---|
| Geon ™ 471 | 44.1% |
| Palatinol ® 610TM | 38.8% |
| Plasthall ® CF | 9.7% |
| Formolon ®-24A | 3.1% |
| Therm-Chek ® 1187 | 1.8% |
| TINUVIN ® XT 833 | 0.22% |
| LOXIOL ® G71S | 0.22% |
| stearic acid | 0.04% |
| 5B8A masterbatch | 2.0% |

TABLE 3
Comparative composition

| | | |
|---|---|---|
| PVC suspension resin | 100 | grams |
| PVC dispersion resin | 7 | grams |
| Linear Phthalate Plasticizer | 50-100 | grams (preferred 75) |
| Epoxidized Soybean Oil | 5-12 | grams |
| Monomeric Adipate Plasticizer | 5-60 | grams (preferred 20) |
| Heat Stabilizers | 3-5 | grams |
| Light Stabilizers | 0.5-1.5 | grams |
| Calcium Carbonate | 2-20 | grams |
| Thermoplastic Elastomer | 35-75 | grams (preferred 38) |

TABLE 4
Physical properties

| | | Tear | Tensile | Elongation | | | | |
|---|---|---|---|---|---|---|---|---|
| | Glass | Strength | Strength | at Break | VOC | Odor at | Odor at | Odor at |
| | Trans. | (ASTM | (ASTM | (ASTM | emissions | 23° C. | 40° C. | 80° C. |
| | Temp. | D1004) | D412) | D412) | (PV3341) | (PV3900) | (PV3900) | (PV3900) |
| Sample Comp. | −60.9° C. | 32.07 kN/m | 9.09 MPa | 325% | 3.53 μg C/g | 1.3 | 1.6 | 1.5 |
| Sample Comp. after | NA | 37.0 kN/m | 8.9 MPa | 327% | NA | NA | NA | NA |
| 500 hours at 120° C. | | | | | | | | |
| Percent Change after | NA | 15.37 kN/m | 2.09 MPa | 0.62% | NA | NA | NA | NA |
| 500 hours at 120° C. | | | | | | | | |
| Prior Art PVC Alloy | −58.7° C. | 36.2 kN/m | 8.8 MPa | 309% | 6.24 μg C/g | 2.0 | 3.0 | 3.3 |
| with Phthalate | | | | | | | | |

While embodiments of the invention have been illustrated and described, it is not intended that these embodiments illustrate and describe all possible forms of the invention. Rather, the words used in the specification are words of description rather than limitation, and it is understood that various changes may be 5 made without departing from the spirit and scope of the invention.

What is claimed is:

1. A polymeric composition comprising:
a) from 35 to 60 wt. percent of a first poly vinyl chloride resin;
b) from 30 to 50 wt. percent linear trimellitate plasticizer; and
c) from 1 to 20 wt. percent adipate ester plasticizer;
wherein the polymeric composition is melt processible to form a skin having volatile organic compound emissions of at most 50 μg C/g.

2. The polymeric composition of claim 1, wherein the linear trimellitate has a molecular weight from 500 to 650.

3. The polymeric composition of claim 1, wherein the linear trimellitate plasticizer is present in an amount from 35 to 45 wt. percent.

4. The polymeric composition of claim 1, wherein the first PVC resin is a suspension resin having a porosity of 0.42 to 0.65 cm³/g.

5. The polymeric composition of claim 4, wherein the porosity of the first PVC resin is from 0.50 to 0.60 cm³/g.

6. The polymeric composition of claim 1, wherein the PVC resin is present in an amount from 35 to 55 wt. percent and wherein the adipate ester plasticizer comprises a modified adipate ester.

7. The polymeric composition of claim 1, further comprising from 1 to 10 wt. percent of a second PVC resin, the second PVC resin being a dispersion resin.

8. The polymeric composition of claim 7, further comprising:
d) up to 5 wt. percent pigment;
e) from 0.5 to 5 wt. percent heat stabilizers;
f) from 0.1 to 2.0 wt. percent light stabilizers;
g) from 0. 1 to 2.0 wt. percent fatty acid ester; and
h) from 0.01 to 1.0 wt. percent stearic acid.

9. The polymeric composition of claim 1, wherein the glass transition temperature of the composition is below -50° C.

10. The polymeric composition of claim 1, wherein the glass transition temperature of the composition is below -60° C.

11. The polymeric composition of claim 1, wherein the formed skin has a tear strength of 30 to 35 kN/m.

12. The polymeric composition of claim 11, wherein the skin's tear strength changes by at most 20 percent after aging 500 hours at 120° C.

13. The polymeric composition of claim 1, wherein the formed skin has a tensile strength at yield of 8 to 11 MPa.

14. The polymeric composition of claim 13, wherein the skin's tensile strength at yield changes by at most 5 percent after aging 500 hours at 120° C.

15. The polymeric composition of claim 1, wherein the skin has an odor grade of less than 2.0 when measured at 23° C., 40° C., and 80° C.

16. The polymeric composition of claim 1, wherein the skin has volatile organic compound emissions of at most 5 μg C/g.

17. A skin for a vehicle interior component, the skin comprising the dried product of a composition comprising:
a) from 35 to 60 wt. percent of a first poly vinyl chloride resin;
b) from 30 to 50 wt. percent linear trimellitate plasticizer; and
c) from 1 to 20 wt. percent adipate ester plasticizer;
wherein the polymeric composition is melt processible to form a skin having volatile organic compound emissions of at most 50 μg C/g.

18. A method of processing a polymeric composition, the method comprising:
a) providing components of the polymer composition, including at least a first poly vinyl chloride resin, a linear trimellitate plasticizer, and an adipate ester plasticizer;
b) inserting at least the PVC resin and a first portion of a blend of the trimellitate and the adipate ester plasticizers into a high intensity mixer;
c) heating the contents of the mixer to a temperature of 170° F. to 220° F. while the mixer is in a first high shear mode;
d) switching the mixer to a first low shear mode and inserting a remaining portion of the trimellitate and adipate ester plasticizers;
e) returning the mixer to a second high shear mode and heating the contents of the mixer to a temperature of 245° F. to 255° F.; and
f) switching the mixture to a second low shear mode and heating the contents of the mixer to a temperature of 255° F. to 265° F.;
wherein the polymeric composition comprises from 35 to 60 wt. percent of a first poly vinyl chloride resin; from 30 to 50 wt. percent linear trimellitate plasticizer; and from 1 to 20 wt. percent adipate ester plasticizer, and wherein the first portion of the blend of the plasticizers comprises 50% to 70% of the total plasticizer weight.

19. The method of claim 19, wherein the first portion of the blend of trimellitate and adipate ester plasticizers comprises about 60% of the total plasticizer weight.

20. The method of claim 19, wherein the first portion of the blend of plasticizers comprises about 75% of a total amount of the trimellitate plasticizer and the remaining portion comprises about 25% of the total amount of trimellitate plasticizer and substantially all of the adipate ester plasticizer.
